(19) United States
(12) Patent Application Publication
(10) Pub. No.: US 2015/0278858 A1
(43) Pub. Date: Oct. 1, 2015

(54) METHOD AND SYSTEM FOR PRODUCING SEGMENT INDEXES

(71) Applicant: EXELATE, New York, NY (US)

(72) Inventors: Kevin Lyons, New York, NY (US); Patrick McCann, Herndon, VA (US)

(73) Assignee: EXELATE, New York, NY (US)

(21) Appl. No.: 14/227,549

(22) Filed: Mar. 27, 2014

(51) Int. Cl. G06Q 30/02

(52) U.S. Cl. CPC G06Q 30/0253; G06Q 30/0269

(57) ABSTRACT

Methods, systems, and media for determining an index of a segment are disclosed. A first value representing one or more first users in a segment that have performed one or more key events may be determined. A second value representing one or more second users of a population that have performed the one or more key events may be determined. A third value representing one or more third users in the segment that have not performed the one or more key events may be determined. A fourth value representing one or more fourth users of the population that have not performed the one or more key events may be determined. The index for the segment may be calculated based on the first value, the second value, the third value, and the fourth value. The index may be transmitted.

### BACKGROUND

This disclosure relates to determining an index of a segment, and more particularly to methods, systems, and media for determining an index of a segment.

Targeting and data collection techniques provide advertisers and other marketing organizations with market segment data related to advertising viewers, including, for example, computer users who view advertising on the World Wide Web (Web) or Internet. For advertising viewers such as Internet users, the available information related to each user depends, for example, on his or her historical Web behavior and, for example, on his or her origin environment, such as the user's computing platform, service provider, country, time of day, etc. A “market segment” or “segment” is a subset, or partial portion of a group that can be characterized in some way; a segment may also be a data object describing such a group.

User identification (ID) data from data publishers can be used to create segment definitions. In general, segment definitions may be characterized by specific values for available properties. For example, segment definitions might exist for categories such as “Gender,” “Age,” and “Nationality” and one segment combination might be defined with three properties as, “Male, 35-40, European.” Once identified (e.g., from information from a data publisher (data seller)), a user who fits the characteristics of “Male, 35-40, European” can be grouped into and/or associated with this segment combination. An advertisement can be exposed to (or placed) with users identified with the segment combination, and data can be collected to determine how the users identified with that segment respond. Behavioral segment definitions for “Shopping Interest,” “Running Interest,” and “Web surfing interest” can be defined and Behavioral attributes, such as “likes to shop,” “intensely likes running,” or “Web surfs in the evening” can also be included in segment combinations. Segment combinations can have attributes that are purely behavioral, purely non-behavioral or a mixture of behavioral and non-behavioral.

In the context of digital media analytics, an index may represent a measurement of an attribute's penetration in a specific audience compared to a more general audience. However, traditional methods of generating indexes suffer from several drawbacks. First, sufficiently large samples or populations must be used before declaring an index reliable and useful. Second, smoothing techniques, which penalize certain values based upon small sample sizes by driving an index closer to 1 or no significance, are often required to account for sample sizes that are so low that the results cannot be trusted.

In general, there is a need for improved techniques for determining an index of a segment, in the advertising and marketing fields in general and, in particular, with regard to Internet advertising.

### SUMMARY

Various embodiments are generally directed to determining an index of a segment to overcome the aforementioned problems.

One or more embodiments may include a method for determining an index of a segment, the method comprising determining, by one or more processors, a first value representing one or more first users in a segment that have performed one or more key events; determining, by one or more processors, a second value representing one or more second users of a population that have performed the one or more key events; determining, by the one or more processors, a third value representing one or more third users in the segment that have not performed the one or more key events; determining, by the one or more processors, a fourth value representing one or more fourth users of the population that have not performed the one or more key events; calculating, by one or more processors, the index for the segment based on the first value, the second value, the third value, and the fourth value; and transmitting the index.

One or more embodiments may include a system for determining an index of a segment, the system comprising: a memory; and a processor coupled to the memory, the processor configured to: determine a first value representing one or more first users in a segment that have performed one or more key events, determine a second value representing one or more second users of a population that have performed the one or more key events, determine a third value representing one or more third users in the segment that have not performed the one or more key events, determine a fourth value representing one or more fourth users of the population that have not performed the one or more key events, calculate the index for the segment based on the first value, the second value, the third value, and the fourth value, and transmit the index.

One or more embodiments may include a computer-readable storage medium for determining an index of a segment, the non-transitory computer readable storage medium comprising instructions that if executed enables a computing system to: determine a first value representing one or more first users in a segment that have performed one or more key events; determine a second value representing one or more second users of a population that have performed the one or more key events; determine a third value representing one or more third users in the segment that have not performed the one or more key events; determine a fourth value representing one or more fourth users of the population that have not performed the one or more key events; calculate the index for the segment based on the first value, the second value, the third value, and the fourth value; and transmit the index.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

Embodiments will now be described in connection with the associated drawings, in which:

FIG. 1 depicts a schematic block diagram of an exemplary system in accordance with one or more embodiments.

FIG. 2 depicts a block flow diagram of an exemplary method 200 for determining an index of a segment in accordance with one or more embodiments.

FIG. 3 depicts an exemplary plurality of attribute vectors 300 in accordance with one or more embodiments.

FIG. 4 depicts an exemplary architecture for implementing a computing device in accordance with one or more embodiments.

### DETAILED DESCRIPTION OF THE DRAWINGS

Exemplary embodiments are discussed in detail below. While specific exemplary embodiments are discussed, it should be understood that this is done for illustration purposes only. In describing and illustrating the exemplary embodiments, specific terminology is employed for the sake of clarity. However, the embodiments are not intended to be limited to the specific terminology so selected. A person skilled in the relevant art will recognize that other components and configurations may be used without parting from the spirit and scope of the embodiments. It is to be understood that each specific element includes all technical equivalents that operate in a similar manner to accomplish a similar purpose. The examples and embodiments described herein are non-limiting examples.

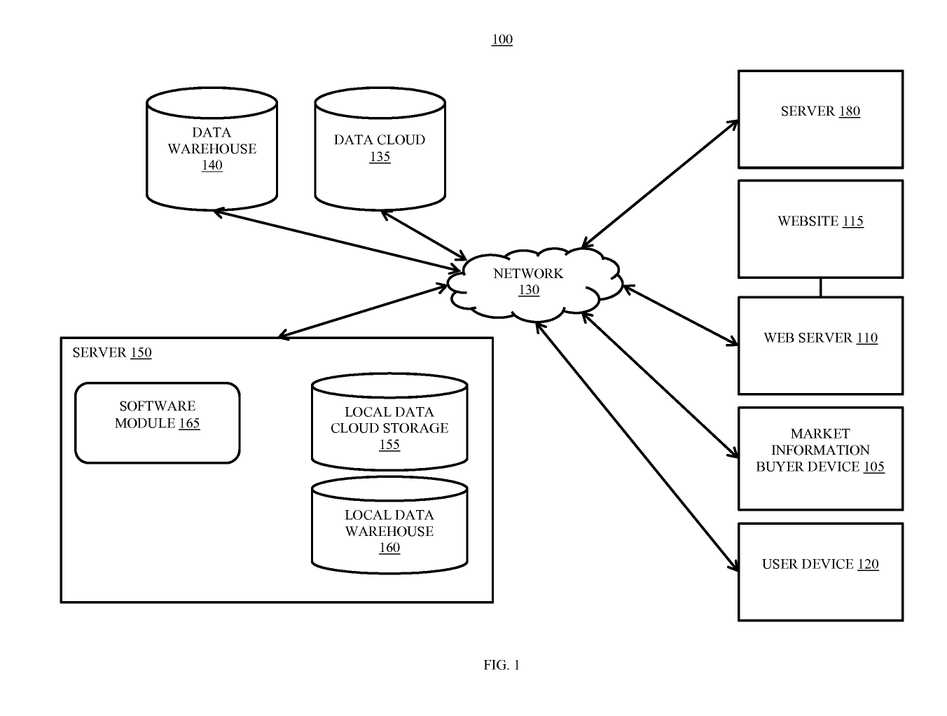

FIG. 1 depicts a schematic block diagram of an exemplary system in accordance with one or more embodiments. System 100 may include market information buyer device 105, web server 110, website 115, user device 120, network 130, data cloud 135, data warehouse 140, server 150, local data cloud storage 155, local data warehouse 160, software module 165, and server 180.

Market information buyer device 105 and user device 120 may be any type of computing device, including a mobile telephone, a laptop, tablet, or desktop computer, a netbook, a video game device, a pager, a smart phone, an ultra-mobile personal computer (UMPC), or a personal data assistant (PDA). Market information buyer device 105 and user device 120 may run one or more applications, such as Internet browsers, voice calls, video games, videoconferencing, and email, among others. Market information buyer device 105 and user device 120 may be any combination of computing devices. These devices may be coupled to network 130. Market information buyer device 105 and user device 120 may store information in cookies and transmit the cookies or other information through network 130 to any other machine, including those depicted in FIG. 1.

Web server 110, server 150, or server 180 may also be any type of computing device coupled to network 130, including but not limited to a personal computer, a server computer, a series of server computers, a mini computer, and a mainframe computer, or combinations thereof. Web server 110, server 150, or server 180 may be a web server (or a series of servers) running a network operating system, examples of which may include but are not limited to Microsoft Windows Server, Novell NetWare, or Linux. Any of the features of server 150 may be also implemented in server 180 and vice versa.

Network 130 may provide network access, data transport and other services to the devices coupled to it. In general, network 130 may include and implement any commonly defined network architectures including those defined by standards bodies, such as the Global System for Mobile communication (GSM) Association, the Internet Engineering Task Force (IETF), and the Worldwide Interoperability for Microwave Access (WiMAX) forum. For example, network 130 may implement one or more of a GSM architecture, a General Packet Radio Service (GPRS) architecture, a Universal Mobile Telecommunications System (UMTS) architecture, and an evolution of UMTS referred to as Long Term Evolution (LTE). Network 130 may, again as an alternative or in conjunction with one or more of the above, implement a WiMAX architecture defined by the WiMAX forum. Network 130 may also comprise, for instance, a local area network (LAN), a wide area network (WAN), the Internet, a virtual LAN (VLAN), an enterprise LAN, a virtual private network (VPN), an enterprise IP network, or any combination thereof.

Website 115 may be any type of website or web page. For example, website 115 may be coded using hypertext markup language (“HTML”), XML, XHTML, JavaScript, Java, Perl, Visual Basic, Hypertext Preprocessor scripts (“PHP”), Active Server Page scripts (“ASP”), common gate interface (“CGI”) scripts, server side includes, and combinations thereof.

Data cloud 135 may be any combination of hardware or software used to store information in a distributed and redundant manner Data cloud 135 may be implemented in or managed by server 150 as local data cloud storage 155, server 180, other servers, or any combination thereof. Data cloud 135 may be distributed across a number of devices, in which each device may replicate all of the data or portions of the data stored on any combination of devices used by data cloud 135. Data cloud 135 may be configured to be updated in real-time when one or more of the devices housing data cloud 135 receives new data. For example, when information is added to or stored on data cloud 135 by server 150, the information may be distributed to other servers maintaining data cloud 135 in real-time. Data cloud 135 may be configured to store any type or combination of data. Data cloud 135 may be configured to only store data for a certain period of time. For example, data cloud 135 may expunge any data that has been in data cloud 135 for more than 60 days. The period of time may be any period of time.

Data warehouse 140 and local data warehouse 160 may be any type of database, including databases managed by a database management system (DBMS). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Oracle database, IBM DB2, Adaptive Server Enterprise, FileMaker, Microsoft Access, Microsoft SQL Server, MySQL, and PostgreSQL. A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. Data structures can include fields, records, files, objects, and any other applicable known or convenient structures for storing data. A DBMS may also include metadata about the data that is stored.

Software module 165 may be a module that is configured to send, process, and receive information at server 150. Software module 165 may provide another mechanism for sending and receiving data at server 150 besides handling requests through web server 110. Software module 165 may send and receive information using any technique for sending and receiving information between processes or devices including using a scripting language, a remote procedure call, an email, a tweet, an application programming interface, Simple Object Access Protocol (SOAP) methods, Common Object Request Broker Architecture (CORBA), any interface for software components to communicate with each other, using any other known technique for sending information from a one device to another, or any combination thereof.

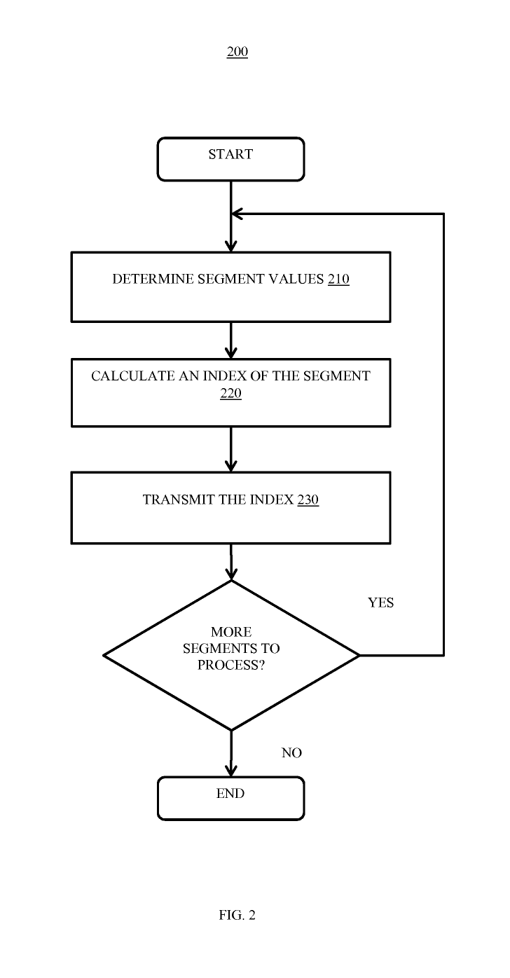

FIG. 2 depicts a block flow diagram of an exemplary method 200 for determining an index of a segment in accordance with one or more embodiments.

In block 210, software module 165 may determine segment values. Segment values may represent information acquired from tracking online user sessions. Segment values may comprise a first value, a second value, a third value, and a fourth value. The first value may represent one or more first users in a segment that have performed one or more key events. The second value may represent one or more second users of a population that have performed one or more key events. The third value may represent one or more third users in the segment that have not performed the one or more key events. The fourth value may represent one or more fourth users of a population that have not performed the one or more key events. Software module 165 may receive the segment values, for example, from one or more memories, one or more data storages, the Internet, one or more networked machines, one or more other machines, user input, one or more values stored in software module 165, or any combination thereof.

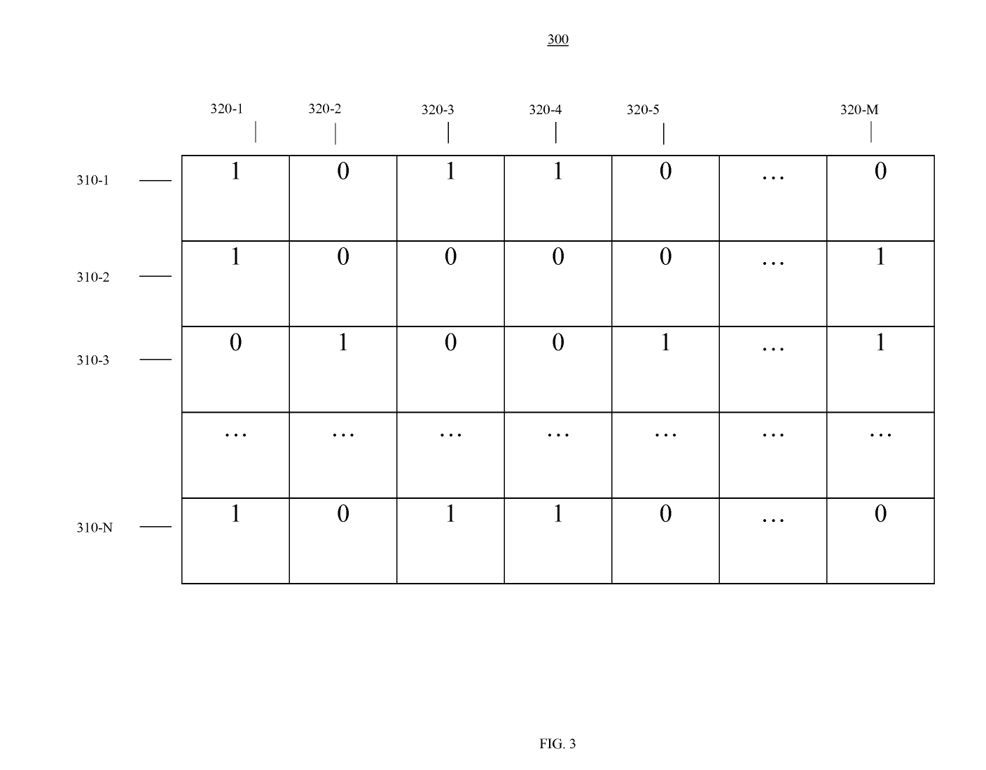

Segment values may include, may be represented by, or may be derived from a plurality of attribute vectors. FIG. 3 depicts an exemplary plurality of attribute vectors 300 in accordance with one or more embodiments. The plurality of attribute vectors 300 may include attribute vectors 310-1 to 310-N. Each vector 310-1 to 310-N may correspond to a user. For example, vector 310-1 may correspond to a first user, and vector 310-N may correspond to an Nth user. The plurality of attribute vectors 300 may include M attributes, which may be stored in columns 320-1 to 320-M. The number of attribute vectors (N) and the number of attributes (M) are not limited to the range of values shown in FIG. 3 and may be any value, including values less than the number of items depicted in FIG. 3. Each attribute may have a range of potential values that may be stored in an attribute vector. For example, the attributes may have a value that is an integer, a Boolean value of true or false, 0 or 1, on or off, etc., a whole number, a real number, an enumerated value, a text value, items in a set, or any combination thereof. An attribute value may be null or undefined. A null or undefined value may represent information that has not yet been determined for the value of the attribute. The values for an attribute may be bounded within a certain range of possible values. For example, the value of attribute 320-1 may be any real number between 0 and 1.

A population may differ from a segment in that the population may be based on the individual attributes or combination of attributes each segment of the population exhibits. In some embodiments, a population may comprise at least one of a plurality of website users; a plurality of Internet users; and a second segment.

In some embodiments, the plurality of attribute vectors 300 may represent information that may be acquired from tracking online user sessions. For example, the attributes may include a date of accessing a particular website; a time of accessing a particular website; whether or not a particular website has been accessed; whether or not a certain protocol has been used, e.g., ftp, http, https, etc.; the area or page of a web site visited; subject or content matter of a website or area or page within a website; user agent and device information; and/or information based upon geographic location from where the device is accessing the internet (GeoIP). The first value, second value, third value, and/or fourth value may be determined using the plurality of attribute vectors.

In some embodiments, the attribute values may be determined by any one or more of the embodiments disclosed in co-pending U.S. patent application Ser. No. 13/682,267 filed Nov. 20, 2012, entitled “MANAGING MODELED AUDIENCE EXTENSION INFORMATION,” attorney docket no. 118308-334904, which is hereby incorporated herein by reference in its entirety.

The plurality of attribute vectors may include a subset that corresponds to one or more users in a segment. A segment may be defined by one or more attributes or attribute values, such that all users that contain the one or more attributes or attributes values are included in the segment. The plurality of attribute vectors may include a subset that corresponds to one or more users that are not in the segment.

The plurality of attribute vectors may include a subset that corresponds to one or more users that have performed one or more key events. A key event may correspond to a conversion, a sale, any path along the sales funnel including being served some sort of advertisement (such as a digital media impression), click through, view through, visiting certain web site or certain areas or pages within a web site, view certain product types, adding certain products to an online shopping cart, abandoning a shopping cart, completing a conversion of sale, or related actions such a recommending a friend, providing a product review, liking a product or service, and any combination thereof.

In some embodiments, the plurality of attribute vectors may be centered; scaled; normalized; regularized, in which low data values under a specified threshold are replaced with a value of zero; smoothed; or any combination thereof. In some embodiments, one or more of the plurality of attribute vectors may be unsmoothed.

In block 220, software module 165 may calculate an index for the segment based. An index may refer to a measurement of one or more attributes' penetration in a specific audience compared to a more general audience. The software module 165 may calculated an index for the segment based on the first value representing one or more first users in a segment that have performed one or more key events, the second value representing one or more second users of a population that have performed the one or more key events, the third value representing one or more third users in the segment that have not performed the one or more key events, and the fourth value representing one or more fourth users of the population that have not performed the one or more key events.

In some embodiments, calculating the index for the segment based on the first value, the second value, the third value, and the fourth value may comprise performing a logarithm on a ratio of a first quantity to a second quantity, wherein the first quantity includes the first value, and wherein the second quantity includes the third value. The first quantity may include an alpha value and the second quantity may include a beta value.

In some embodiments, calculating the index for the segment based on the first value, the second value, the third value, and the fourth value may comprise performing a logarithm on a ratio of a first quantity to a second quantity, wherein the first quantity includes the second value, and wherein the second quantity includes the fourth value. Although these exemplary ratios are discussed, other ratios may be used for calculating the index.

The first, second, third, and fourth values may correspond to values of a Bayesian model. An exemplary Bayesian model may be as follows. Given that C is an audience segment and L is a key event, an inference may be drawn about p(L|C), i.e., the probability of having key event L given a particular audience segment C. p(L|C) may be centered around p(L), i.e., the probability of key event L. p(L) may be observable with very high provision. A beta prior may be the initial information of the probability of success of a certain action based upon prior knowledge, as represented by the model with parameters in Equation 1:

$$α , β = α ( \frac{P ( {L}^{′} )}{P ( L )} )$$

Where α is some integer larger than one and L′ is the complement of L. For most conversion campaigns, L′ may be approximately the same as the entire audience of the Internet. This contrasts with Laplace smoothing, where α=β=1. This prior has the desirable properties that when L is very small, and C∩L and C∩L′ equal zero, the Naive Bayes coefficient, as shown in Equation 2:

$$ln ( \frac{C ⋂ L + α}{C ⋂ {L}^{′} + β} ) - ln ( \frac{L}{{L}^{′}} )$$

equals zero, and the expected value of p(L|C) equals p(L). The index may then be calculated using the following, Equation 3:

$$exp ( ln ( \frac{C ⋂ L + α}{C ⋂ {L}^{′} + β} ) - ln ( \frac{L}{{L}^{′}} ) )$$

Unsmoothed, or when α=β=0, this equation may simplify to Equation 4:

$$( \frac{\frac{C ⋂ L}{L}}{\frac{C ⋂ {L}^{′}}{L}} )$$

Thus, in some embodiments, the index may be calculated using the Equation 4.

In some embodiments, software module 165 may receive any or all of the values used in Equation 1 through Equation 4 instead of or in addition to calculating them from the plurality of attribute vectors. The values may be received from one or more memories, one or more data storages, the Internet, one or more networked machines, one or more files, one or more other machines, one or more user inputs, one or more values stored in software module 165, or any combination thereof

In block 230, software module 165 may transmit the index. The index may be transmitted to one or more memories, one or more data storages, the Internet, one or more networked machines, one or more other machines, one or more display devices, one or more files, one or more users, one or more values stored in software module 165, or any combination thereof.

In block 240, software module 165 may determine whether there are more segments to process. If software module 165 determines there are more segments to process, any or all of steps 210-240 may be repeated. If software module 165 determines there are no more segments to process, method 200 may end.

In some embodiments, one or more indexes of one or more segments may be compared, and an action may be taken based on the comparison. For example, one or more segments having the greatest values may be identified. Actions taken based on the comparison may include delivering targeted advertisements to the users of the one or more identified segments, consumer insights for marketers seeking to maximize their understanding of their customers and consumer behavior, and any combination thereof.

For example, the indexes may be used with a full prior understanding of the business need, careful consideration and planning prior to technical implementation, correct technical implementation, careful consideration of results, and then imaginative ongoing business practices to maximize the value of key findings.

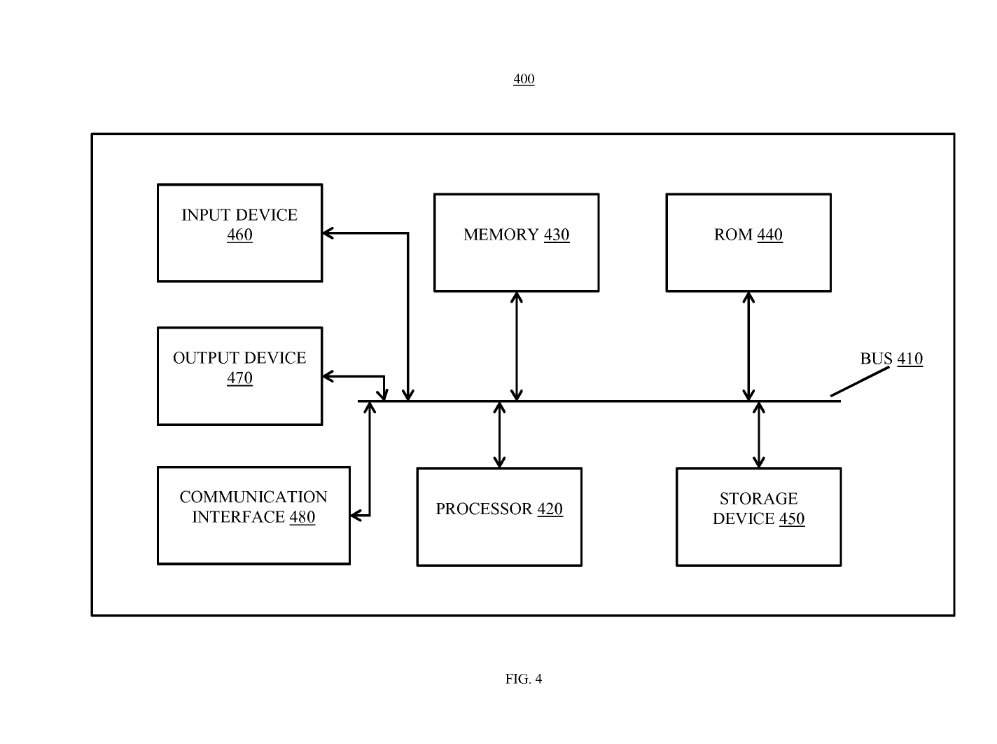

FIG. 4 depicts an exemplary architecture for implementing a computing device 400 in accordance with one or more embodiments, which may be used to implement any of market information buyer device 105, web server 110, user device 120, 150, server 180, data cloud 135, data warehouse 140, or any other computer system or computing device component thereof. It will be appreciated that other devices that can be used with the computing device 500, such as a client or a server, may be similarly configured. As illustrated in FIG. 4, computing device 400 may include a bus 410, a processor 420, a memory 430, a read only memory (ROM) 440, a storage device 450, an input device 460, an output device 470, and a communication interface 480.

Bus 410 may include one or more interconnects that permit communication among the components of computing device 400. Processor 420 may include any type of processor, microprocessor, or processing logic that may interpret and execute instructions (e.g., a field programmable gate array (FPGA)). Processor 420 may include a single device (e.g., a single core) and/or a group of devices (e.g., multi-core). Memory 430 may include a random access memory (RAM) or another type of dynamic storage device that may store information and instructions for execution by processor 420. Memory 430 may also be used to store temporary variables or other intermediate information during execution of instructions by processor 420.

ROM 440 may include a ROM device and/or another type of static storage device that may store static information and instructions for processor 420. Storage device 450 may include a magnetic disk and/or optical disk and its corresponding drive for storing information and/or instructions. Storage device 450 may include a single storage device or multiple storage devices, such as multiple storage devices operating in parallel. Moreover, storage device 450 may reside locally on the computing device 400 and/or may be remote with respect to a server and connected thereto via network and/or another type of connection, such as a dedicated link or channel.

Input device 460 may include any mechanism or combination of mechanisms that permit an operator to input information to computing device 400, such as a keyboard, a mouse, a touch sensitive display device, a microphone, a pen-based pointing device, and/or a biometric input device, such as a voice recognition device and/or a finger print scanning device. Output device 470 may include any mechanism or combination of mechanisms that outputs information to the operator, including a display, a printer, a speaker, etc.

Communication interface 480 may include any transceiver-like mechanism that enables computing device 400 to communicate with other devices and/or systems, such as a client, a server, a license manager, a vendor, etc. For example, communication interface 480 may include one or more interfaces, such as a first interface coupled to a network and/or a second interface coupled to a license manager. Alternatively, communication interface 480 may include other mechanisms (e.g., a wireless interface) for communicating via a network, such as a wireless network. In one implementation, communication interface 480 may include logic to send code to a destination device, such as a target device that can include general purpose hardware (e.g., a personal computer form factor), dedicated hardware (e.g., a digital signal processing (DSP) device adapted to execute a compiled version of a model or a part of a model), etc.

Computing device 400 may perform certain functions in response to processor 420 executing software instructions contained in a computer-readable medium, such as memory 430. In alternative embodiments, hardwired circuitry may be used in place of or in combination with software instructions to implement features consistent with principles of the invention. Thus, implementations consistent with principles of the invention are not limited to any specific combination of hardware circuitry and software.

Exemplary embodiments may be embodied in many different ways as a software component. For example, it may be a stand-alone software package, a combination of software packages, or it may be a software package incorporated as a “tool” in a larger software product. It may be downloadable from a network, for example, a website, as a stand-alone product or as an add-in package for installation in an existing software application. It may also be available as a client-server software application, or as a web-enabled software application. It may also be embodied as a software package installed on a hardware device.

Numerous specific details have been set forth to provide a thorough understanding of the embodiments. It will be understood, however, that the embodiments may be practiced without these specific details. In other instances, well-known operations, components and circuits have not been described in detail so as not to obscure the embodiments. It can be appreciated that the specific structural and functional details are representative and do not necessarily limit the scope of the embodiments.

It is worthy to note that any reference to “one embodiment” or “an embodiment” means that a particular feature, structure, or characteristic described in connection with the embodiment is included in at least one embodiment. The appearances of the phrase “in one embodiment” in the specification are not necessarily all referring to the same embodiment.

Although some embodiments may be illustrated and described as comprising exemplary functional components or modules performing various operations, it can be appreciated that such components or modules may be implemented by one or more hardware components, software components, and/or combination thereof. The functional components and/or modules may be implemented, for example, by logic (e.g., instructions, data, and/or code) to be executed by a logic device (e.g., processor). Such logic may be stored internally or externally to a logic device on one or more types of computer-readable storage media.

Some embodiments may comprise an article of manufacture. An article of manufacture may comprise a storage medium to store logic. Examples of a storage medium may include one or more types of computer-readable storage media capable of storing electronic data, including volatile memory or non-volatile memory, removable or non-removable memory, erasable or non-erasable memory, writeable or re-writeable memory, and so forth. Examples of storage media include hard drives, disk drives, solid state drives, and any other tangible storage media.

It also is to be appreciated that the described embodiments illustrate exemplary implementations, and that the functional components and/or modules may be implemented in various other ways which are consistent with the described embodiments. Furthermore, the operations performed by such components or modules may be combined and/or separated for a given implementation and may be performed by a greater number or fewer number of components or modules.

Some of the figures may include a flow diagram. Although such figures may include a particular logic flow, it can be appreciated that the logic flow merely provides an exemplary implementation of the general functionality. Further, the logic flow does not necessarily have to be executed in the order presented unless otherwise indicated. In addition, the logic flow may be implemented by a hardware element, a software element executed by a processor, or any combination thereof.

While various exemplary embodiments have been described above, it should be understood that they have been presented by way of example only, and not limitation. Thus, the breadth and scope of the present invention should not be limited by any of the above-described exemplary embodiments, but should instead be defined only in accordance with the following claims and their equivalents.

1. A method for determining an index of a segment, the method comprising:
determining, by one or more processors, a first value representing one or more first users in a segment that have performed one or more key events;
determining, by one or more processors, a second value representing one or more second users of a population that have performed the one or more key events;
determining, by the one or more processors, a third value representing one or more third users in the segment that have not performed the one or more key events;
determining, by the one or more processors, a fourth value representing one or more fourth users of the population that have not performed the one or more key events;
calculating, by one or more processors, the index for the segment based on the first value, the second value, the third value, and the fourth value; and
transmitting the index.

2. The method of claim 1, wherein calculating, by one or more processors, the index for the segment based on the first value, the second value, the third value, and the fourth value further comprises:
performing a logarithm on a ratio of a first quantity to a second quantity, wherein the first quantity includes the first value, and wherein the second quantity includes the third value.

3. The method of claim 2, wherein the first quantity includes an alpha value and the second quantity includes a beta value.

4. The method of claim 1, wherein calculating, by one or more processors, the index for the segment based on the first value, the second value, the third value, and the fourth value further comprises:
performing a logarithm on a ratio of a first quantity to a second quantity, wherein the first quantity includes the second value, and wherein the second quantity includes the fourth value.

5. The method of claim 1, wherein the one or more key events correspond to at least one of a conversion, a sale, any path along the sales funnel including being served some sort of advertisement, a click through, a view through, visiting certain web site or certain areas or pages within a web site, a view certain product types, adding certain products to an online shopping cart, abandoning a shopping cart, completing a conversion of sale, recommending a friend, providing a product review, liking a product or service, or any combination thereof.

6. The method of claim 1 further comprising:
receiving a plurality of attribute vectors of a plurality of users; and
determining at least one of the first value, the second value, the third value, and the fourth value using the plurality of attribute vectors.

7. The method of claim 6, wherein values of the plurality of attribute vectors are unsmoothed.

8. A method for determining a second index of a second segment, the method comprising:
performing the method of claim 1 on the second segment to produce the second index.

9. The method of claim 1 further comprising:
comparing the index to one or more indexes of one or more segments; and
taking an action based on the comparison.

10. The method of claim 1, wherein the population comprises at least one of:
a plurality of website users;
a plurality of Internet users; and
a second segment.

11. A system for determining an index of a segment, the system comprising:
a memory; and
a processor coupled to the memory, the processor configured to:
determine a first value representing one or more first users in a segment that have performed one or more key events,
determine a second value representing one or more second users of a population that have performed the one or more key events,
determine a third value representing one or more third users in the segment that have not performed the one or more key events,
determine a fourth value representing one or more fourth users of the population that have not performed the one or more key events,
calculate the index for the segment based on the first value, the second value, the third value, and the fourth value, and
transmit the index.

12. The system of claim 11, wherein calculating the index for the segment based on the first value, the second value, the third value, and the fourth value further comprises:
performing a logarithm on a ratio of a first quantity to a second quantity, wherein the first quantity includes the first value, and wherein the second quantity includes the third value.

13. The method of claim 12, wherein the first quantity includes an alpha value and the second quantity includes a beta value.

14. The method of claim 11, wherein calculating the index for the segment based on the first value, the second value, the third value, and the fourth value further comprises:
performing a logarithm on a ratio of a first quantity to a second quantity, wherein the first quantity includes the second value, and wherein the second quantity includes the fourth value.

15. The method of claim 11, wherein the one or more key events correspond to at least one of a conversion, a sale, any path along the sales funnel including being served some sort of advertisement, a click through, a view through, visiting certain web site or certain areas or pages within a web site, a view certain product types, adding certain products to an online shopping cart, abandoning a shopping cart, completing a conversion of sale, recommending a friend, providing a product review, liking a product or service, or any combination thereof.

16. The system of claim 11, wherein the processor is further configured to:
receive a plurality of attribute vectors of a plurality of users; and
determine at least one of the first value, the second value, the third value, and the fourth value using the plurality of attribute vectors.

17. The system of claim 16, wherein values of the plurality of attribute vectors are unsmoothed.

18. The system of claim 11, wherein the processor is further configured to:
compare the index to one or more indexes of one or more segments; and
take an action based on the comparison.

19. The method of claim 11, wherein the population comprises at least one of:
a plurality of website users;
a plurality of Internet users; and
a second segment.

20. A non-transitory computer readable storage medium for determining an index of a segment, the non-transitory computer readable storage medium comprising instructions that if executed enables a computing system to:
determine a first value representing one or more first users in a segment that have performed one or more key events;
determine a second value representing one or more second users of a population that have performed the one or more key events;
determine a third value representing one or more third users in the segment that have not performed the one or more key events;
determine a fourth value representing one or more fourth users of the population that have not performed the one or more key events;
calculate the index for the segment based on the first value, the second value, the third value, and the fourth value; and
transmit the index.
